(19) United States
(12) Patent Application Publication
(10) Pub. No.: US 2003/0070569 A1
(43) Pub. Date: Apr. 17, 2003

(54) Micro-stencil

(76) Inventors: Colin Bulthaup, Menlo Park, CA (US); Brian Hubert, Menlo Park, CA (US); Kevin Hubert, West Lafayette, IN (US); Joseph Jacobson, Newton, MA (US)

Correspondence Address: HAVERSTOCK & OWENS LLP, Suite 420, 260 Sheridan Avenue, Palo Alto, CA, 94306, US

(21) Appl. No.: 10/007,122

(22) Filed: Dec. 4, 2001

Related U.S. Application Data
(60) Provisional application No. 60/328,591, filed on Oct. 11, 2001.

(51) Int. Cl. B41L 13/00; B05C 17/06; B05C 17/08; B41L 47/46; B41J 1/00; B44D 2/00; B41M 1/12; C25F 3/00; B28B 5/00; B29C 63/00; B29C 65/00; B29C 69/00; B28B 1/14; B29C 39/00; B29C 41/00

(52) U.S. Cl. 101/127; 101/91; 101/129; 101/93.01; 216/11; 264/241; 264/299

(57) ABSTRACT

The current invention is directed to micro-stencil devices and methods. A micro-stencil, in accordance with this invention, comprises a patterned stencil membrane formed from a polymeric layer patterned with stencil features preferably having lateral dimensions in a range of 10 micron to 100 nanometers or less. The micro-stencil preferably includes a porous backing membrane coupled to the stencil membrane to control the flow of print fluids, to allow for two-way flow of print fluids and/or curing gases during a printing operation. The stencil membrane is preferably configured to directly print the stencil features onto a suitable print medium surface. The micro-stencil of the instant invention, is preferably utilized for printing structures comprising interconnected layers, such as micro-circuits, and/or structures comprising polymer arrays.

### RELATED APPLICATION(S)

This Patent Application claims priority under 35 U.S.C. 119 (e) of the co-pending U.S. Provisional Patent Application, Serial No. 60/328,591, filed Oct. 11, 2001, and entitled “MICRO-STENCIL”. The Provisional Patent Application, Serial No. 60/328,591, filed Oct. 11, 2001, and entitled “MICRO-STENCIL” is also hereby incorporated by reference.

### FIELD OF THE INVENTION

The present invention relates to printing. More specifically, this invention relates to printing micro-structures using micro-stencils.

### BACKGROUND OF THE INVENTION

There is a continual push to fabricate structures with smaller dimensions for use in electronics, optics, chemistry and biochemistry. Structures having dimensions of less than a few hundred nanometers are generally referred to as nano-structures. While methods of patterning nano-structures are a central focus for a number of emerging technologies, patterning structures with dimensions of less than even 1.0 micron is typically difficult to carry out reproducibly and economically.

Standard photo-lithographic techniques are most commonly used to fabricate micro-structures and multi-layer devices. Each layer is patterned using mask and etch techniques. Surfaces often need to be cleaned between each mask and etch step. Such processes are limited to patterning materials that are unreactive or inert to the masking materials or masking processes used. Further, lithographic techniques are generally expensive and difficult to reproduce for patterning sub-micron structures and, therefore, do not hold out much promise for patterning of nano-structures. Therefore, there continues to be a need to provide methods of patterning structures with micron and sub-micron dimensions reproducibly and in a cost effective manner.

A number of alternative mechanical techniques have shown promise for producing sub-micron structures under some circumstances. For example, structures with lateral dimensions as small as 50 to 30 nanometers using polymeric stamp techniques. In Unconventional Methods for Fabricating and Patterning Nano-structures, published in Chem. Rev. 1999, Volume 99, pp. 1823-1848, Xia Younan et al. provide an overview of the current state of the art in nano-fabrication technologies, as well as describe some of the shortcomings of previously explored techniques. In summary, none of these previously studied nano-fabrication methods have been shown to be useful for reproducibly producing multiple structures from a single cast. Further, the nano-fabrication methods studied by Younan et al. are generally only useful for patterning a single layer of material and do not provide for the ability to fabricate networks of interconnected layers.

Typical photo-lithographic techniques require forming a continuous layer of a structure and then removing unwanted portions. Therefore, there is a need for an alternative to photo-lithographic patterning techniques for fabricating devices with smaller dimensions for use in electronics, optics, chemistry and biochemistry.

### SUMMARY OF THE INVENTION

The current invention is directed to a stencil device, system and method. The device of the instant invention comprises a micro-stencil for printing features onto a print medium surface. The micro-stencil can be configured with stencil features having any suitable dimensions for the application at hand. The micro-stencil of the instant invention is preferably configured with stencil features having lateral dimensions less than 100 microns. The micro-stencil of the instant invention can be configured with stencil features having lateral dimensions as small as several hundred nanometers or less. In the method of the instant invention, micro-stencils are utilized in single or multiple step print processes to fabricate print structures from suitable print fluids.

Print fluids include any substances which can be passed through a micro-stencil, in accedence with the instant invention, and print stencil features onto a suitable print medium surface. Accordingly, print fluids herein include gases, liquids, liquid suspensions, dispersions, solids and combinations thereof. Gas print fluids, for example can include a reactive etchant gas and an inert carrier gas. Suitable liquid print fluids include dye solutions, solvated or coordinated metal solutions and polymeric solutions. Dispersion or suspension print fluids include nano-particle solutions comprising nano-particles of metals, semiconductors, dielectrics/insulators and combinations thereof.

Nano-particle solutions comprising nano-particles formed from metals (such as Au, Ag or Cu), semiconductors (such as CdS CdSe, Si, Ge, GaAs) or dielectrics (such as SiO₂, TiO₂) that are dispersed in a suitable solvent such as Pyridine or alpha-Terpineol, are particularly useful in the instant invention. Applications for nano-particle solutions and their preparation are described in U.S. patent application Ser. No. 09/334,873, filed Jun. 17, 1999, entitled “Nano Particle-Based Electrical, Chemical, and Mechanical Structures and Methods of Making Same”, now U.S. Pat. No. 6,294,401 and U.S. patent application Ser. No. 09/519,722, filed Mar. 3, 2000, entitled “Method for Manufacturing Electrical and Electro-mechanical Elements and Devices by Thin Film Deposition and Imaging”, the contents of which are both hereby incorporated by reference.

Micro-stencils utilized in the instant invention are preferably formed from a polymeric material such as rubber, silicone, urethane, vinyl, acrylic, nylon or any combination thereof. In several embodiments of the instant invention, a micro-stencil is preferably formed from a polymeric material which exhibits a low-surface energy in order to reduce adhesion of the print fluid to the micro-stencil during a print operation. One material which exhibits a low-surface energy and is, therefore, particularly useful in this regard is polydimethylsiloxane (PDMS).

The micro-stencil of the instant invention has a stencil membrane that is preferably formed from a polymeric layer that can be cured to a thickness of less than 1.0 micron or less. The stencil membrane can be formed from a polymeric layer that is cured to a thickness of several hundred nanometers or less. The preferred thickness of the stencil membrane and the dimensions of the stencil features both depend on the application at hand and the properties of the print fluid(s) used. In the preferred embodiment of the invention, a thinner membrane is attached to a thicker porous support backing, wherein the pore size of the backing is at least twice as small as the lateral dimension of the smallest stencil feature. In this way, the micro-stencil is said to comprise a multi-layer membrane structure. The porous support backing is critical for providing support to an ultra-thin membrane.

The micro-stencil preferably has a receptor surface for receiving print fluids and a print surface for directing print fluids onto a print medium. The print medium can comprise silicon, such as a silicon-based wafer surface. Alternatively, a print medium can comprise glass, quartz, sapphire, plastic and metal or any combination thereof.

In operation, a print fluid passes through a flow region of the micro-stencil. Preferably the flow region comprises one or more passages between the stencil features that pass completely through the stencil membrane. In accordance with an embodiment of the invention, the micro-stencil comprises a reservoir for holding and supplying one or more print fluids to the print surface of the micro-stencil. The reservoir is preferably coupled through the receptor surface of the micro-stencil and can provide print fluid for a multiple number of prints.

In a preferred embodiment of the invention, the reservoir comprises a porous material that is coupled to the receptor surface of the micro-stencil, the flow region of the micro-stencil or a combination thereof. There are a number of porous materials that can be used with pore sizes ranging form 100 microns to 30 nanometers depending on the application at hand. A number of suitable porous materials are available from Millipore Corporation, 80 Ashby Road, Bedford Mass. 01730.

The porous material can serve several functions. The porous material can hold print fluid and supply the print fluid to the print surface of the medium. The porous material can also control the flow and/or amount of the print fluid applied to the print medium surface during a printing operation. The porous material can also provide mechanical support for the stencil membrane which is particularly important when the stencil membrane is ultra-thin. Also, the porous material or porous backing provides for two-way flow through the stencil membrane. Accordingly, print fluid can flow to a print medium surface through the membrane, and drying or curing gases can be removed from the printed surface through the membrane, while the membrane remains in contact with the print medium surface, as described in detail below.

Materials that are suitable for forming a porous backing include but are not limited to metals (such as aluminum and silver), glass, glass fibers, quartz, polymer foams, mixed cellulose, polycarbonate, polytetrafluoroethylene (PTFE), nylon, polyether sulfone (PES), polypropylene, mixed cellulose and polyvinylidene fluoride (PVDF). The porous material or backing can be made to be hydrophilic or hydrophobic depending on the application at hand.

A micro-stencil, in accordance with the instant invention, can be formed by depositing or coating a membrane layer onto a suitable substrate. Portions of the membrane layer can then be selectively removed from the substrate to form the stencil features. Portions of the membrane layer can be selectively removed from the substrate using any suitable physical, chemical or optical technique, including laser ablation, ion beam treatment, electron beam treatment and reactive ion etch. The patterned membrane layer can then be released from the substrate surface to provide a release membrane that is patterned with the stencil features. Alternatively, the substrate is formed from a porous material that allows the printing fluid to flow from the substrate and to the patterned membrane layer attached thereto. The membrane layer can be from any suitable material, but is preferably formed from a flexible and elastic polymer material.

In further embodiments of the instant invention, a stencil structure is formed by selectively depositing a non-porous material defining the stencil features onto a suitable support structure that is either porous or non-porous. Also, the micro-stencil can be formed by selectively patterning a porous material, which can then be used as the micro-stencil, or can then be selectively coated with non-porous polymer to define the stencil features, as explained below.

In yet further embodiments of the instant invention, a micro-stencil membrane is patterned from a stamp having a master surface comprising stencil features. The stamp is formed from glass, quartz, sapphire, silicon, silicon nitride, silicon oxide, plastic, a combination thereof and/or any other suitable material. The stamp is preferably patterned with a negative impression of the stencil features to be patterned into, and preferably, through the stencil membrane. The stamp is preferably patterned using standard lithographic techniques or any other suitable patterning technique which provides stencil features required to pattern the stencil membrane. In accordance with this embodiment, a liquid material is deposited as a layer between the master surface of the stamp and a suitable support substrate. The support substrate is formed from any suitable material including glass, quartz, sapphire, silicon, silicon nitride, silicon oxide and plastic. The stencil features are then embossed into the liquid layer by pressing the stamp and the substrate together. The quality or sharpness of the embossed stencil features is believed to be improved when one of either the master surface or the support substrate is more flexible than the other.

After the stencil features are embossed into the liquid polymer, the liquid polymer is cured while pressed between the stamp and the support substrate. Alternatively, the liquid polymer is cured after being embossed by the stamp and releasing the stamp from the embossed liquid polymer.

In one embodiment, the liquid polymer is cured while pressed between the stamp and the support substrate. Then the patterned membrane can be released from the stamp and/or the support substrate. The stamp and/or support substrate can be formed form a porous material such that a print fluid can flow through the stamp and/or support substrate to the stencil membrane attached thereto. Also, portions of the stamp and/or support substrate can be selectively etched away or otherwise removed from regions between stencil features of the stencil membrane to provide a flow region or passages for directing a print fluid onto a print medium. Regardless of the method used to form the micro-stencil membrane, the micro-stencil is preferably configured to directly transfer a print fluid onto a print medium onto only the desired portions.

The system of the instant invention comprises a micro-stencil with stencil features, as described above. The system also preferably includes a print fluid supply coupled to the micro-stencil stencil for providing a print fluid to the print surface of the micro-stencil. The system also preferably comprises a mechanism for coupling a print medium to the print surface of the micro-stencil. The mechanism for coupling a print medium to the print surface of the micro-stencil preferably comprises a press structure (for complete contact printing) or a roll drum (for roll out printing).

In further embodiments of the instant invention, the system comprises one or more pressure regulators for controllably regulating the pressure differential between the print medium and the print fluid and/or the stencil membrane to facilitate flow of the print fluid through the stencil membrane and onto the print medium.

In yet further embodiments of the instant invention, the system further comprises means to align the print medium with the micro-stencil. The means to align the print medium with the micro-stencil preferably comprises an optical device, such as a microscope that measures the alignment of selected portions of the micro-stencil with selected portions of the print medium. For example, a microscope can be used to measure marks located on the micro-stencil with a complimentary set of marks on the print medium and provides alignment instructions to a computer and/or movable table to bring the marks into alignment. Alignment of the micro-stencil with the print medium can be particularly important when producing multi-layer print structures which require accurate overlap between prints.

In accordance with a preferred method of the instant invention, micro-stencils are utilized to print bio-chip arrays or micro-circuits.

### BRIEF DESCRIPTION OF THE DRAWINGS

FIGS. 1a-d show a micro-stencil and printing with the micro-stencil, in accordance with the instant invention.

FIGS. 2a-c show micro-stencils with fluid reservoirs comprising porous features for holding and supplying print fluids to the print surfaces, in accordance with the instant invention.

FIGS. 3a-e show using a stamp with a master surface for making a micro-stencil membrane, in accordance with the instant invention.

FIGS. 4a-d show using masking techniques for making a micro-stencil membrane, in accordance with the instant invention.

FIGS. 5a-d show using a stamp with a master surface for making a patterned micro-stencil membrane, wherein the stamp provides support for the patterned membrane, in accordance with the instant invention.

FIGS. 6a-c show making a micro-stencil membrane through direct patterning of a membrane layer, in accordance with the instant invention.

FIGS. 7a-c show making a micro-stencil membrane using a squeegee technique, in accordance with the instant invention.

FIG. 8 shows making a micro-stencil using selective deposition of a stencil membrane onto a suitable support structure, in accordance with the instant invention.

FIGS. 9a-d show making a micro-stencil by selectively etching a porous support structure and modifying the etched structure to define stencil features, in accordance with the instant invention.

FIGS. 10a-b show forming a porous support backing of micro-stencil structure from a non-porous backing while coupled to a micro-stencil membrane, in accordance with an alternative method of the instant invention.

FIGS. 11a-b show a print system with a micro-stencil, in accordance with the instant invention.

FIGS. 12a-g show steps for making a multi-layer print structure, in accordance with the method of the instant invention.

### DETAILED DESCRIPTION OF THE PREFERRED EMBODIMENTS

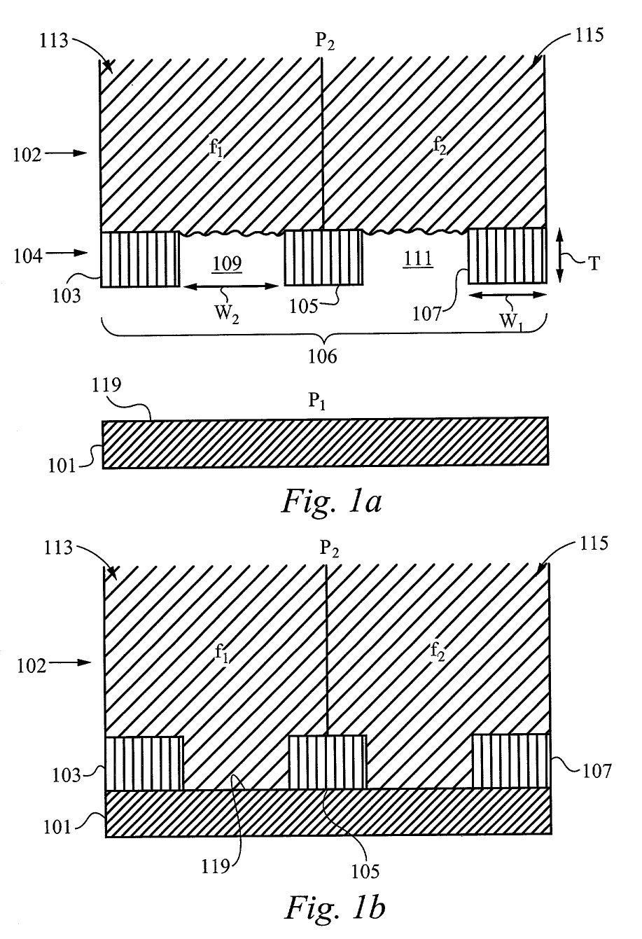

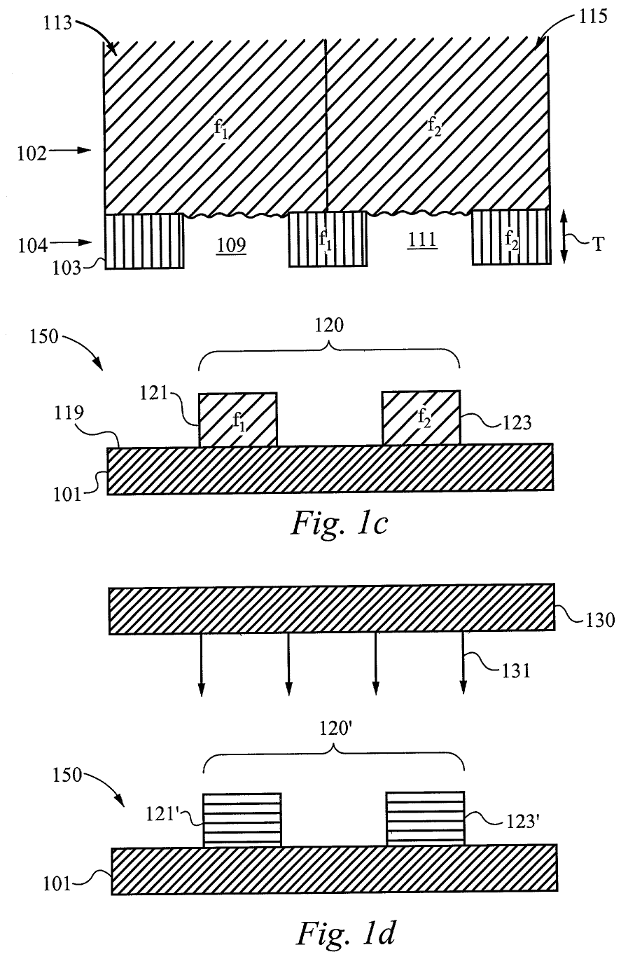

FIGS. 1a-d illustrate cross-sectional views of a micro-stencil 102 and a method of using the micro-stencil 102, in accordance with the instant invention. Referring to FIG. 1a, the micro-stencil 102 comprises a stencil membrane 104 patterned with raised stencil features 103, 105, 107 and recessed stencil features 109 and 111. Preferably, a portion of the stencil features 103, 105, 107, 109, and 111 are patterned to have lateral dimensions W₁ and W₂ in a range of 100 microns to 100 nanometers depending the application at hand. The stencil features 103, 105, 107, 109, and 111 can be patterned to have lateral dimensions W₁ and W₂ as small as several tens of nanometers. At least a portion of the recessed stencil features 109 and 111 pass through the stencil membrane 104, such that print fluids f₁ and f₂ can flow into the recessed stencil features 109 and 111 under print conditions. It will be apparent that the print fluids f₁ and f₂ can be a common print fluid. Under certain circumstances, to promote the flow of print fluids f₁ and f₂ into the recessed stencil features 109 and 111, the pressures P₁ and P₂ can be controlled in order to maintain a predetermined pressure differential across the stencil membrane 104. Preferably, the pressures P₁ and P₂ are controlled to maintain a condition wherein P₂>P₁ during printing. However, there are certain circumstances after printing and/or during a print process where it may be preferable that P₂<P₁.

The stencil membrane 104 is preferably coupled to one or more reservoirs 113 and 115 for holding and supplying print fluids f₁ and f₂ to the print surface 106 of the stencil 102. The stencil 102 is preferably utilized to provide direct printing of print fluids f₁ and f₂ onto only desired regions of the surface 119 of the print medium 101.

The stencil membrane 104 is preferably formed from a flexible material such as rubber, silicone, urethane, vinyl, acrylic, nylon or any combination thereof. The stencil membrane 104 preferably has a thickness T of less than 1.0 microns and can have a thickness of less than 500 nanometers. In a preferred embodiment of the instant invention, the stencil membrane 104 is formed from a polymeric material which exhibits a low-surface energy in order to reduce adhesion of print fluids f₁ and f₂ to the micro-stencil 104 during a print operation. A material which exhibits a low-surface energy and is, therefore, particularly useful in this regard is polydimethylsiloxane (PDMS).

Print fluids f₁ and f₂ include, but are not limited to gases, liquids, suspensions of nano-particles, solids and combinations thereof. A suitable print medium can comprise staining agents, such as dyes, metals (such as aluminum, silver, gold, platinum, and palladium), semi-conductor particles (such as CdSe, CdS, Ge and GaAs), biological materials (including amino acids and amino acids sequences), and insulators (such as SiO₂, Al₂O₃).

Still referring to FIG. 1a, the print medium 101 is any suitable print medium including glass, quartz, sapphire, plastic and metal. The print medium 101 can comprises silicon, wherein the surface 119 of the medium 101 is silicon, silicon nitride, silicon oxide, or silicon doped with phosphorus or boron. The surface 119 of the substrate 101 is a virgin surface (viz. without print) or, alternatively comprises a print from a previous processing step as described in detail below.

Referring to FIG. 1b, in operation the surface 119 of the print medium 101 and the printing surface 106 of the stencil 102 are brought together such that print fluids f₁ and f₂ can flow from reservoirs 113 and 115 through the stencil features 109 and 111. The print fluids f₁ and f₂ can flow from gravity, surface tension, capillary action, controlled pressure differential, electro wetting or a combination thereof. The selection of flow mode will depend upon the characteristics of the print fluids f₁ and f₂ as well as the feature size(s) of the stencil. After print fluids f₁ and f₂ are transferred to the surface 119 of the medium 101, as shown in FIG. 1c, the stencil 102 and the medium 101 are separated to provide a print 120 comprising print features 121 and 123.

Referring now to FIG. 1d, the print 120 can be cured with radiation 131 from a radiation source 130 to produce a cured print 120′ print comprising solid print features 121′ and 123′. Whether the print 120 is cured and how the print 120 is cured depends on the characteristics print fluids f₁ and f₂ used and the intended purpose of the print structure 150. For example, when the print fluids f₁ and f₂ are stains, inks or solvent based fluids, curing can be accomplished by air drying and/or heating the print structure 150. When fluids f₁ and f₂ are molecular species which bond with the surface 119 of the medium 101, curing is not necessarily required and the print structure 150 may, in some cases, remain preserved in a fluid environment. However, when the fluids f₁ and f₂ are cross-linking materials or photo-chemistry materials, ultra violet radiation or another suitable curing radiation can be used to cure the print 120 to form the cured print 120′.

While the micro-stencil 102, shown in FIGS. 1a-c, comprise two reservoirs 113 and 115 for holding and supplying two print fluids f₁ and f₂, micro-stencils with any number of reservoirs and print fluids are considered within the scope of the invention. Further, the micro-stencil of the instant invention can be configured to print with a single print fluid, as described in examples below.

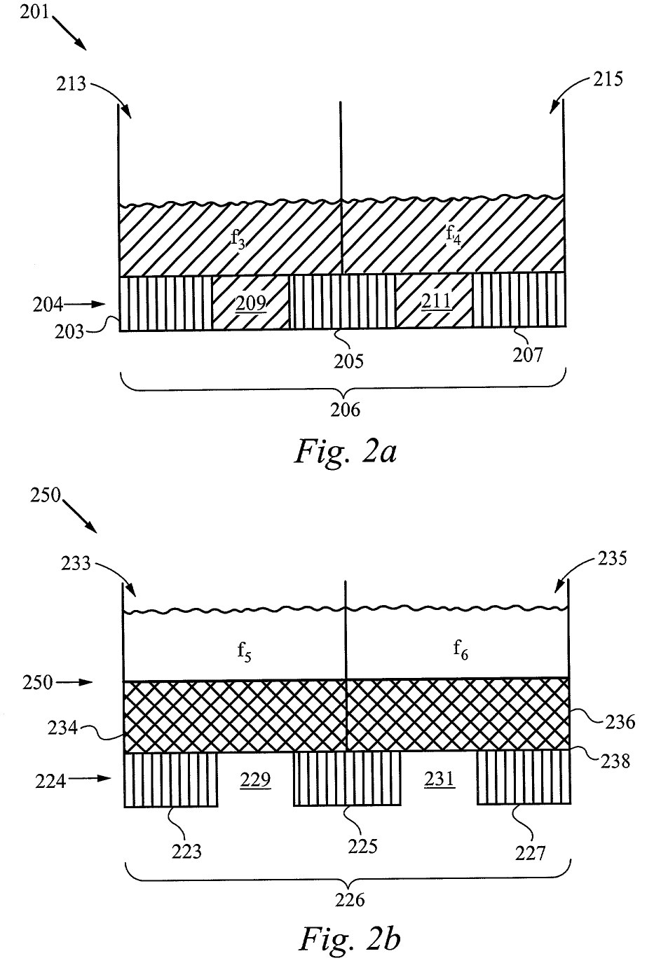

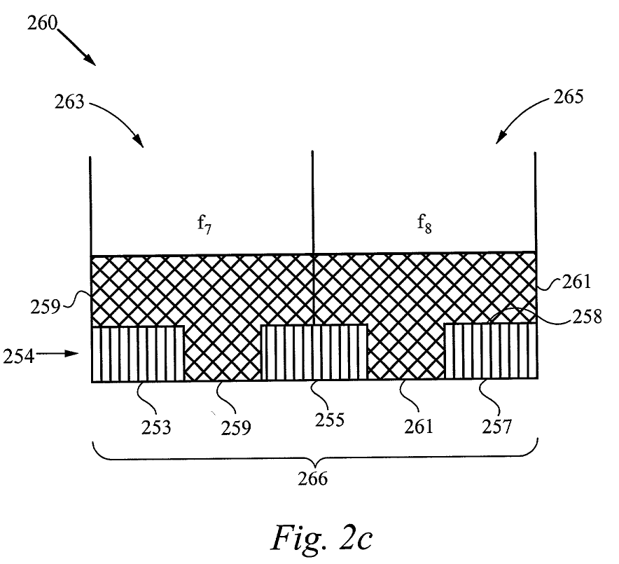

FIGS. 2a-c illustrate further embodiments of the instant invention, wherein the micro-stencil comprises a porous material(s) which can hold print fluid, supply the print fluid to the print surface of the print medium, facilitate the controlled flow of print fluid applied to the print surface and/or provide for mechanical support for the stencil membrane 204.

Suitable porous materials include, but are not limited to, metals (including aluminum and silver), glass, quartz, polymer foams, mixed cellulose, polycarbonate, polytetrafluoroethylene (PTFE), nylon, polyether sulfone (PES), polypropylene, mixed cellulose, polyvinylidene fluoride (PVDF) and polydimethyl sidoxane (PDMS). The porous material or backing can be made to be hydrophilic or hydrophobic and have a wide range, typically 100 microns to 10 nanometers, of pore sizes depending on the application at hand. In general, a pore size, or range of pore sizes, is chosen such that the print fluid and suspension particles within the print fluid can diffuse through the porous material. As a rule of thumb, the average pore size should be at least ten times the size of the suspension particles and at least two-times smaller than the minimum stencil features size.

Now referring to FIG. 2a, a micro-stencil 201 comprises a stencil membrane 204 patterned with raised stencil features 203, 205 and 207. Porous stencil features 209 and 211 are positioned between the raised stencil features 203, 205 and 207. The stencil membrane 204 is preferably in communication with one or more reservoirs 213 and 215 for holding and supplying print fluids f₃ and f₄ to a print surface 206 of the micro-stencil 201, as previously described.

Now referring to FIG. 2b, a micro-stencil 250 comprises a stencil membrane 224 patterned with raised stencil features 223, 225 and 227 and recessed stencil features 229 and 231. In accordance with this embodiment, one or more porous features 234 and 236 are coupled to a receptor surface 238 of the stencil membrane 224. The stencil membrane 224 is preferably coupled to one or more reservoirs 233 and 235 for holding and supplying print fluids f₅ and f₆ to a print surface 226 of the micro-stencil 250 through the porous features 234 and 236. Depending upon the characteristics of the print fluids f₅ and f₆, a pressure differential or electro wetting can be used to force the print fluids f₅ and f₆ through the porous features 234 and 236.

Now referring to FIG. 2c, a micro-stencil 260 comprises a stencil membrane 254 patterned with stencil features 253, 255 and 257. In accordance with this embodiment, one or more porous features 259 and 261 are positioned between the stencil features 253, 255 and 257 and are coupled to a receptor surface 258 of the stencil membrane 254. Preferably, porous features 259 and 261 have a thickness that is greater than the stencil membrane 254, to provide improved support and structural integrity for the membrane 254. The stencil membrane 254 is preferably coupled to one or more reservoirs 263 and 265 for holding and supplying print fluids f₇ and f₈ to a print surface 266 of the micro-stencil 260 through the porous features 259 and 261.

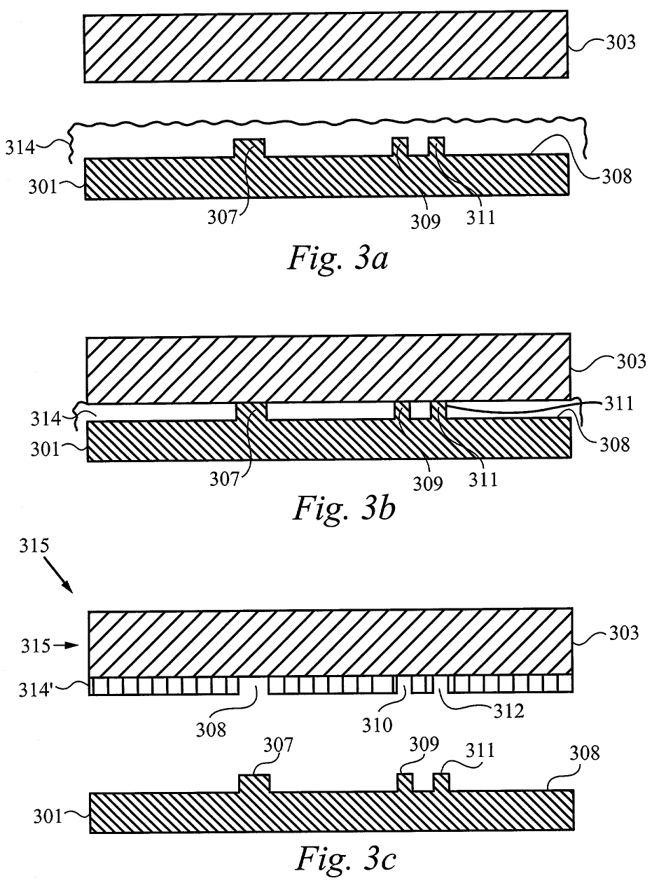

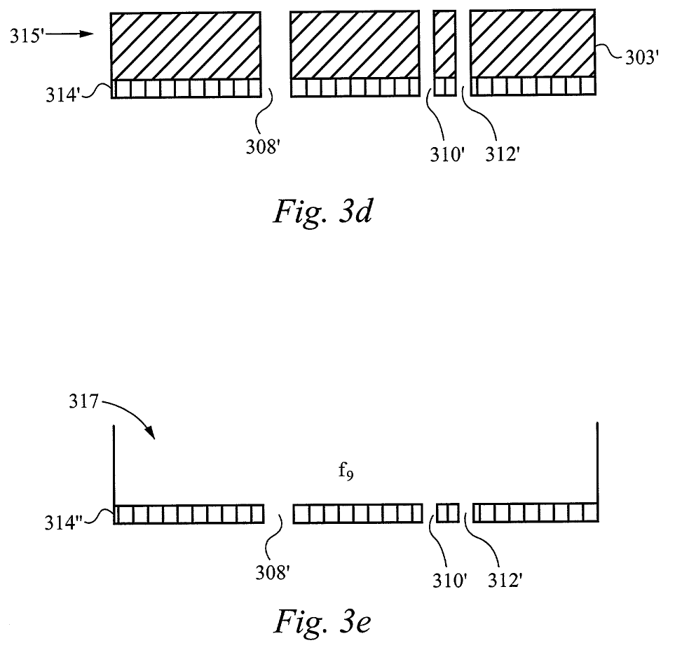

FIGS. 3a-3e illustrate a method of patterning a micro-stencil membrane, in accordance with the instant invention. Referring to FIG. 3a, a micro-stencil membrane is patterned from a stamp 301 having master surface 308 patterned with stencil features 307, 309 and 311. The stamp 301 is formed from metal glass, quartz, sapphire, silicon, silicon nitride, silicon oxide, a combination thereof and/or any other suitable material including polymeric materials such as PDMS. The stamp 301 is preferably patterned with the a negative impression of the stencil features to be patterned into the stencil membrane. However, the stamp 301 can be patterned with a positive impression of the stencil features to be patterned into the stencil membrane and/or used to provide support and structural integrity for the patterned membrane, as explained below. The stamp 301 is preferably patterned using standard lithographic techniques or any other suitable patterning technique which provide the stencil topography required to pattern the stencil membrane, including the embossing techniques, described by Xia Younan et al. in Unconventional Methods for Fabricating and Patterning Nano-structures, published in Chem. Rev. 1999, Volume 99, pp. 1823-1848.

Still referring to FIG. 3a, a liquid 314 is deposited as a layer between the master surface 308 of the stamp 301 and a suitable support substrate 303. It will be clear to one skilled in the art that the liquid 314 can be deposited on the stamp 301 or on the support substrate. Preferably, the liquid 314 is a polymer liquid that can be cured to form a solid polymer structure. The support substrate 303 is formed from any suitable material including metal, glass, quartz, sapphire, silicon, silicon-nitride and silicon-oxide. The support substrate 303 can also be formed from a suitable polymer such PDMS or a porous material such as a polymer foam, mixed cellulose, polycarbonate, polytetrafluoroethylene (PTFE), nylon, polyether sulfone (PES), polypropylene, mixed cellulose and polyvinylidene fluoride (PVDF).

Referring to FIG. 3b, the stencil features 307, 309 and 311 are impressed into the liquid polymeric layer 314 by bringing the stamp 301 and the substrate 303 together. The liquid polymeric layer 314 is then cured while pressed between the stamp 301 and the support substrate 303 to form the cured membrane 314′ with recessed stencil features 308, 310 and 312 corresponding as the stencil features 307, 309 and 311, respectively as shown in FIG. 3c. Alternatively, the liquid polymer 314 can be cured after releasing the stamp 301.

Still referring to FIG. 3c, the stencil structure 315 comprising the support substrate 303 and the attached membrane 314, can be used as micro-stencil 315 when the support substrate 303 is formed from a suitably porous material, as previously described. Alternatively, selected portions of the support substrate 303 can be removed to provide channels or passages 308′ 310′ and 312′ through the support 303′ and through the membrane 314′ to form the stencil structure 315′, as shown in FIG. 3d. Alternatively, the membrane 314′ is released from the support substrate 303 using mechanical separation, dissolution of the support substrate 303 or other suitable means to form a release membrane 314″. The release membrane 314″ can then be used to provide direct printing to a medium, by coupling the release membrane 314″ to a print fluid f₉ and reservoir 317.

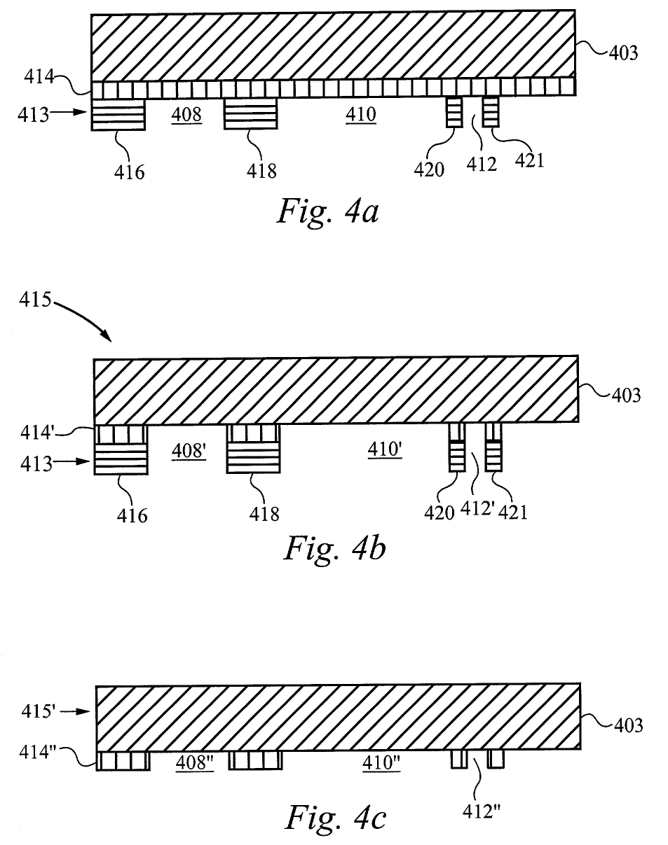

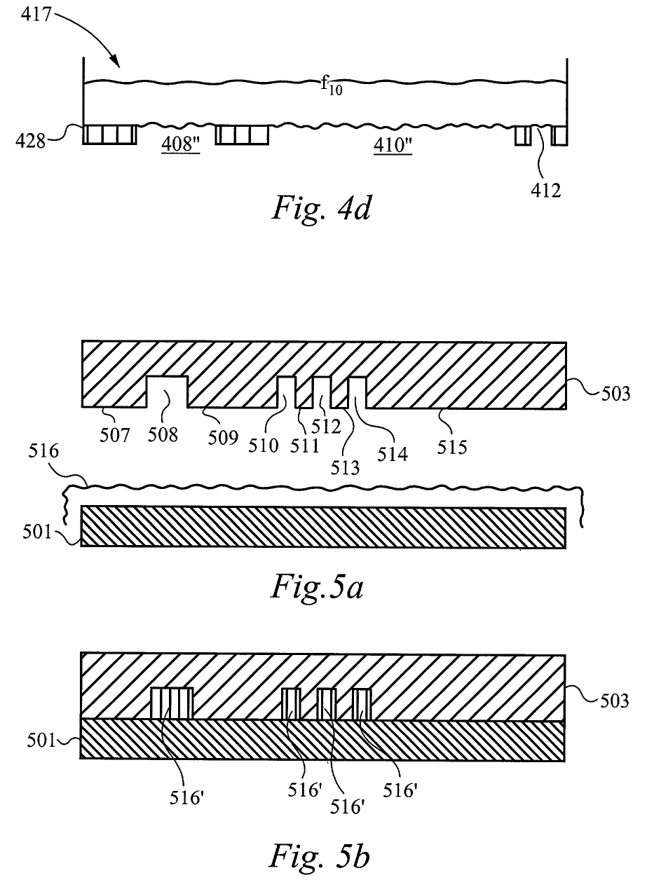

In a further embodiment of the invention, a micro-stencil structure is formed using masking and etching techniques, such as illustrated in FIGS. 4a-d. Referring to FIG. 4a, a membrane layer 414 is formed on a suitable substrate 403. In accordance with this embodiment the membrane is preferably formed from an etchable material such as a silicon based material and/or metal. On an outer surface of the membrane layer 414, a mask 413 is formed having a plurality of raised mask features 416, 418, 420 and 421 and a plurality of recessed mask features 408, 410 and 412. The mask 413 is formed with a photoresist material or other suitable masking material, including metal, that allows the membrane layer 414 to be selectively etched through the recessed mask features 408, 410 and 412. The mask 413 can be formed using embossing techniques, including liquid embossing techniques described in U.S. patent application Ser. No. 09/525,734, filed Sep. 13, 2000, entitled “Fabrication of Finely Featured Devices by Liquid Embossing”, the contents of which are hereby incorporated by reference. Alternatively, the mask 413 is formed using lithographic techniques or other mask patterning methods.

Now referring to FIG. 4b, the membrane layer 414 is selectively etched through the recessed mask features 408, 410 and 412 to form a patterned membrane layer 414′ with recessed membrane features 408′, 410′ and 412′. The micro-stencil structure 415 can be used to print onto a medium, when the substrate 403 is formed from a suitably porous material, as explained previously. Alternatively, the mask 413 is removed to expose the patterned membrane 414′ therebelow and then the micro-stencil structure 415′ can be used to print onto a suitable medium, when the substrate 403 is formed from a suitably porous material, as shown in FIG. 4c. Further, the substrate 403 can be selectively etched in the recess regions 408″, 410″ and 412″ to provide channels or passages through the membrane 414″ and/or the substrate 403, as previously shown in FIG. 3d. Alternatively, the substrate 403 can be released from the membrane 414″ to form the release membrane 428, as shown in FIG. 4d. The release membrane 428 can then be coupled to a print fluid f₁₀ through a reservoir 417 for printing onto a print medium.

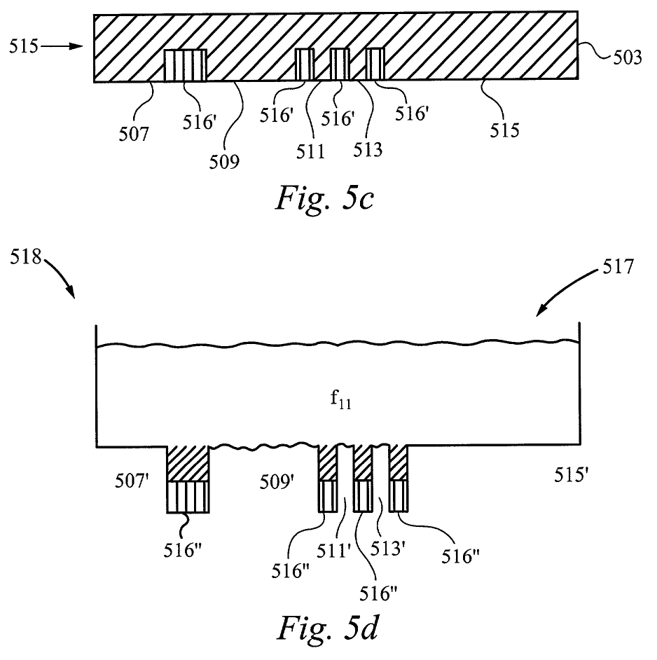

In yet further embodiments of the instant invention, a membrane is formed with a stamp having a master surface patterned with positive stencil features, wherein the stamp provides support for the membrane during the fabrication of the micro-stencil. Referring to FIG. 5a, a liquid material 516 is deposited as a layer between a master surface of a stamp 503 and a substrate 501. The master surface of the stamp 503 has protruding stamp features 507, 509, 511, 513 and 515 and recessed stamp features 508, 510, 512 and 514. The stamp 503 can be formed from metal, glass, quartz, sapphire, silicon, silicon nitride, silicon oxide, a combination thereof and/or any other suitable material including a polymeric material, such as PDMS. The stamp 503 can be patterned using embossing techniques discussed in U.S. patent application Ser. No. 09/525,734, filed Sep. 13, 2000, entitled “Fabrication of Finely Featured Devices by Liquid Embossing”, or alternatively, the stamp can be patterned using lithographic techniques, wherein stamp features are etched into the master surface of the stamp 503. The substrate 501 is formed from any suitable material including metal, glass, quartz, sapphire, silicon, silicon nitride, silicon oxide, polymer or any combination thereof.

Referring to FIG. 5b, the stencil features 516′ are impressed into the liquid polymeric layer 516 (FIG. 5a) by bringing the stamp 503 and the substrate 501 together to form the membrane 516′. The membrane 516′ is then cured while pressed between the stamp 503 and the substrate 501, or the membrane 516′ is then cured after being released from the substrate 501, as shown in FIG. 5c.

Referring to FIG. 5c, the micro-stencil structure 515 can be used to print onto a suitable medium when the stamp 503 is formed from a suitable porous material, such that a print fluid can flow from the features 507, 509, 511, 513 and 515 onto the medium, as previously explained. Alternatively, the stencil features 507, 509, 511, 513 and 515 are selectively removed to form the channels or passages 507′, 509′, 511′, 513′ and 515′, as shown in FIG. 5d. The micro-stencil structure 518 can then be coupled to a suitable reservoir 517 to supply a print fluid f₁₁ to the print surface of the micro-stencil 518, as previously explained.

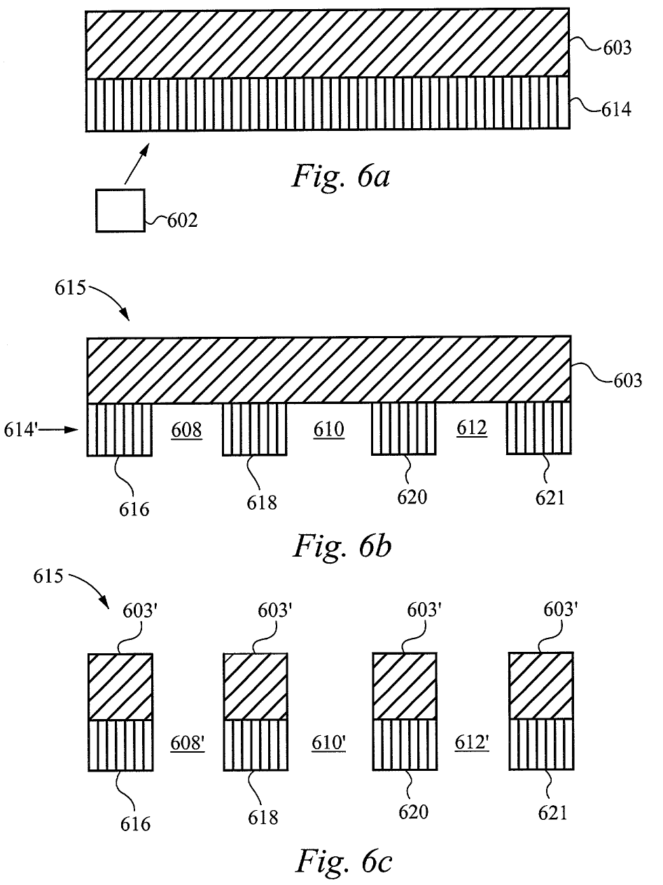

In still further embodiments of the instant invention, a micro-stencil membrane is formed by direct patterning. Referring to FIG. 6a, a suitable membrane material 614 is deposited onto a substrate 603. The membrane material 614 is a preferably a polymeric material such as PDMS, that is cured to form a solid layer. Portions of cured membrane material 614 are then selectively removed to form recessed features 608, 610 and 612 using, mechanical, chemical, optical means, or any other suitable means. For example, a laser source 602 is used to ablate the recessed features 608, 610 and 612 through the cured membrane material 614. In accordance with this embodiment, the substrate is preferably a silicon-based material that can be readily etched in a subsequent step.

Now referring to FIG. 6b, after the patterned membrane 614′ is formed, the stencil structure 615 can be used to print, when the substrate 603 is formed from a suitably porous material. Alternatively, in a subsequent step as shown in FIG. 6c, selected portions of the substrate 603 are etched to form etched substrate 603′ with channels or passages 608′, 610′ and 612′ between the stencil features 616, 618, 620 and 621. The etched micro-stencil structure 615′ is then used to print a stencil pattern onto a medium surface through the channels or passages 608′, 610′ and 612′.

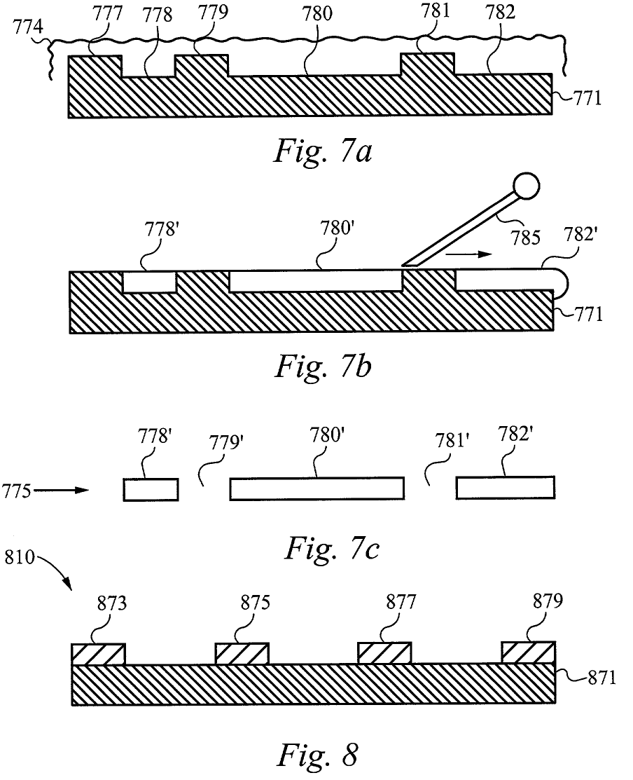

Referring to FIG. 7a, a micro-stencil membrane can be fabricated by depositing a liquid material 774 onto a support substrate 771 patterned with protruding stencil features 777, 779 and 781 and receding stencil features 778, 780, 782. In accordance with this embodiment, the liquid layer 774 is squeegeed with a squeegee device (such as a doctor blade or draw-down bar) 785 such that the squeegeed liquid 778′, 780′ and 782′ fills, or partially fills, the receding stencil features 778, 780 and 782. The squeegeed liquid 778′, 780′ and 782′ is then cured, as previously described, and can be released from the support substrate 771 to form the release membrane structure 775 with membrane features 778′, 780′ and 782′ and membrane flow regions 779′ and 781′ which pass through the membrane structure 775 as shown in FIG. 7c. Alternatively, the cured squeegeed membrane 775 can remain attached to the patterned support structure 771 and used as a micro-stencil when the patterned support substrate 771 is suitably porous, as previously described, or the release membrane structure 775 can be reattached to a support surface of choice

Referring now to FIG. 8, a micro-stencil structure 810 can also be made by selectively depositing non-porous features 873, 875, 877 and 879 onto a suitable porous or non-porous substrate 871. The non-porous features 873 can be made from any number of different materials including metals, silicon-based materials, polymers and other materials that can be selectively deposited using any deposition technique known in the art, including lithographic masking and deposition techniques, embossing, and ink jet printing.

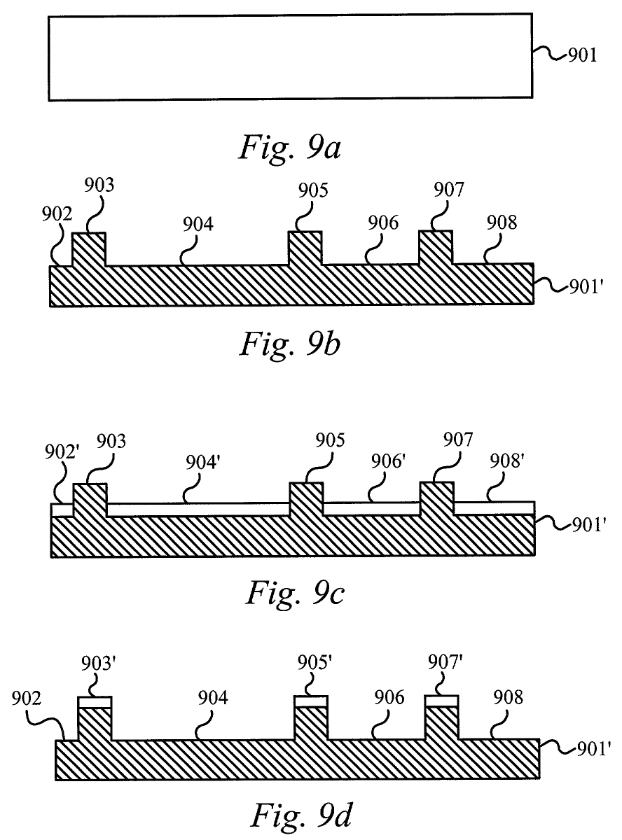

In yet a further embodiment of the instant invention, a micro-stencil structure is formed by patterning a suitable porous material with stencil features, as shown in FIGS. 9a-d. Referring to FIG. 9a, a suitable porous substrate 901, such as those previously mentioned, is provided. The substrate 901 is patterned using any chemical, physical or optical method suitable for patterning the substrate 901 with a relief surface comprising protruding features 903, 905, 907 and receding features 902, 904, 906 and 908, as shown in FIG. 9b.

The patterned substrate 901′ can be used as a micro-stencil structure without further modification to the relief surface or, alternatively, the receding features 902, 904, 906 and 908 can be filled, or partially filled, with a non-porous material, such as a polymer or metal, to form the features 902′, 904′, 906′ and 908′, shown in FIG. 9c. Accordingly, print fluid can be applied to a print medium through the porous protruding features 903, 905 and 907. Alternatively, the protruding features 903, 905 and 905 are coated with a layer of a non-porous material, such as a polymer or metal, to form the modified protruding features 903′, 905′ and 907′, wherein the recessed features 902, 904, 906 and 908 are used to deliver a print fluid to a print medium surface.

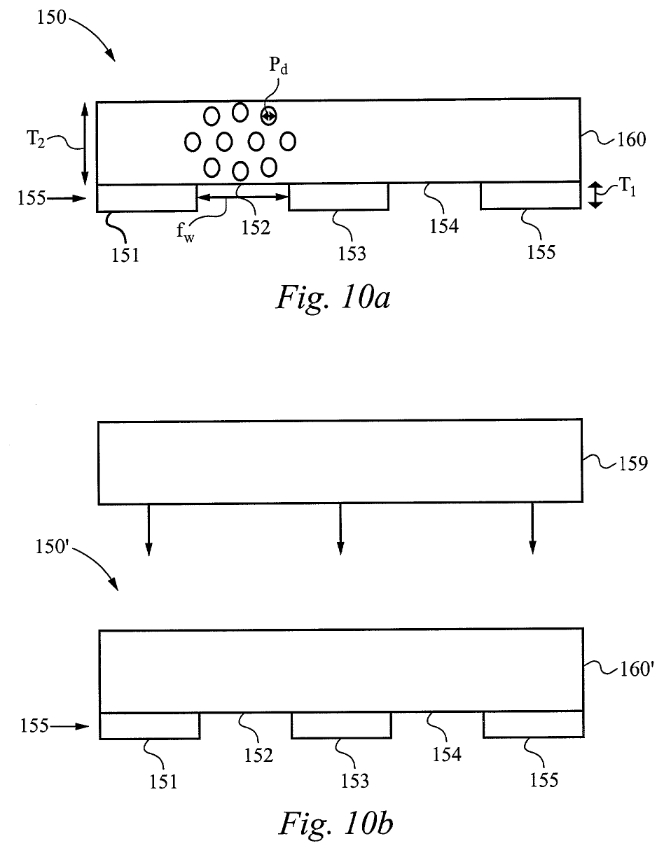

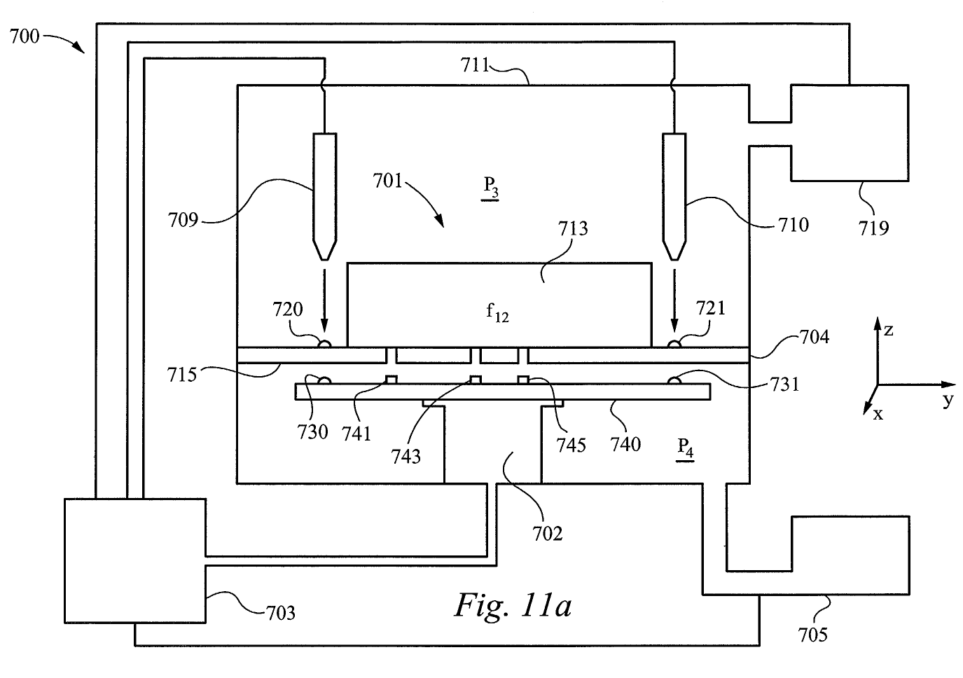

Now referring to FIG. 10a, in a preferred embodiment of the instant invention, a micro-stencil structure 150 comprises a thicker porous backing membrane 160 that is attached to a thinner non-porous stencil membrane 155 patterned with raised stencil features 151, 153 and 155 and recessed stencil features 152 and 154, as previously described. In this way, the micro-stencil structure 150 is a multi-layer membrane stencil structure. The porous backing membrane 160 and the stencil membrane 155 are formed from any number of materials, such as those described previously. While the porous backing membrane 160 can have any number pore sizes between 100 microns to 10 nanometers, it is preferably that the average pore size P_{d} is at least ten times the size of the suspension particles within the print fluid (not shown) and is at least two-times smaller than the minimum stencil features size F_{w}. It is also preferable that the thickness T₂ of the porous backing membrane 160 is several times thicker than the thickness T₁ of the stencil membrane 155, and that the entire stencil structure 150 is flexible to conform to irregular, patterned or printed surfaces. The thickness T₂ of the porous backing membrane is preferably in a range of 1.0 to 10.0 microns, although any range of backing thicknesses are considered to be within the scope of the instant invention.

Referring to FIG. 10b, a structure 150′ can be initially formed with non-porous backing 160 attached to a thinner non-porous stencil membrane 155 patterned with the raised stencil features 151, 153 and 155 and the recessed stencil features 152 and 154. The non-porous backing membrane 160 can then be treated with a chemical and/or radiation source 159 suitable to render the non-porous backing 160′ porous, thereby producing the micro-stencil structure 150. For example, a non-porous backing membrane 160′ is formed form a composite of etchable material in a non-etchable binder, wherein treating the non-porous backing membrane 160′ with a suitable enchant dissolves or removes the etchable material leaving pores in the binder material to render the non-porous backing 160′ porous. Also porous membranes can be rendered non-porous through treatments with chemicals and/or suitable radiation sources. For example, a porous membrane can be heat treated causing the porous network within the membrane to collapse, thereby rendering the membrane non-porous.

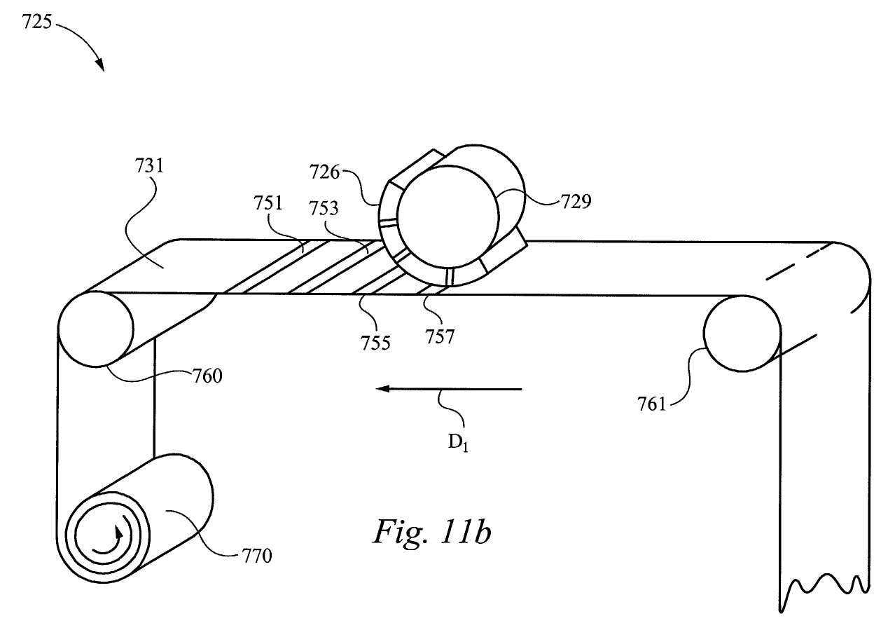

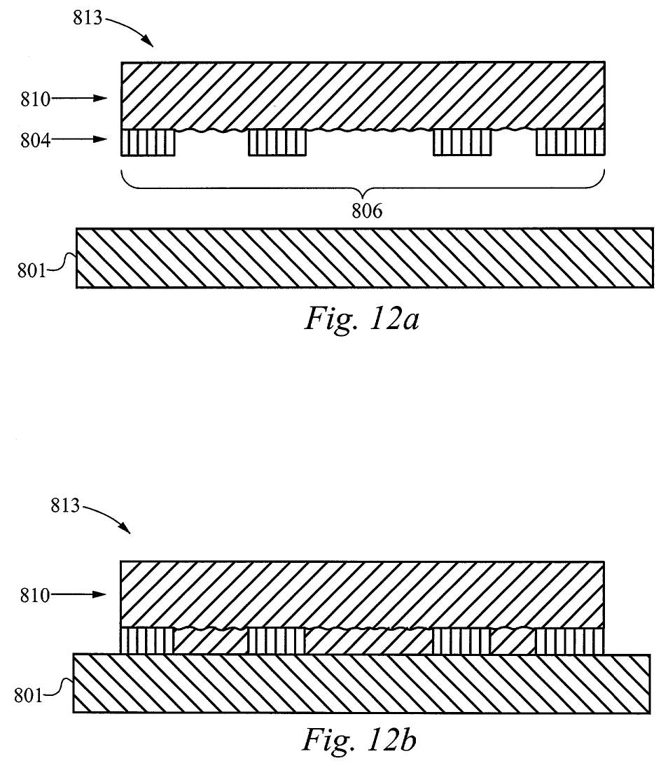

As shown in FIG. 11a, the system 700 of the instant invention comprises a micro-stencil structure 701 with a stencil membrane 704 and a print fluid reservoir 713 for supplying a print fluid f₁₂ to a print surface 715 of the membrane 704, as previously described. The system 700 also preferably has a mechanism for coupling a print medium 740 to the print surface 715 of the micro-stencil 704. In an embodiment of the instant invention, the mechanism for coupling a print medium 740 to the print surface 715 of the stencil membrane 704 comprises a press structure or motorized table structure 702. The motorized table structure 702 is preferably capable of moving up and down in the Z direction and is also capable of the adjusting the position of the print medium 740 in the X and Y plane.

In further embodiments of the instant invention, the system 700 comprises means to align the print medium 740 with the micro-stencil 701. The means to align the print medium 740 with the micro-stencil 701 preferably comprises one or more optical microscopes 709 and 710 that measures the alignment of the stencil 701 with the print medium 740. For example, the microscopes 709 and 710 measure the position of a set of marks 720 and 721 on the micro-stencil 704 relative to a set of complimentary marks 730 and 731 on the print medium 740. The microscopes 709 and 710 send signals to a computer 703 to instruct the table structure 702 to move in the X and Y plane until the marks 720 and 721 are sufficiently aligned with complimentary marks 730 and 731. The computer 703 then is configured to send a signal that instructs the table structure 702 to move in the Z direction and thereby print the features 741, 743 and 745 onto the print medium 740 from the membrane 704. The system 700 can be one processing station within a multi-station processing system, whereby the printed medium 740 is removed with a robotic arm and transferred to the next processing station, while a new print medium is placed onto the table structure 702 for a subsequent printing task.

The system 700 can be configured with an isolation chamber 711 with one or more pressure regulators 705 and 719. The pressure regulators 705 and 719 are preferably configured for controlling the pressure(s) P₃ and P₄. Preferably the pressure regulators 705 and 719 control the pressures P₃ and P₄, such that there is a pressure differential across the membrane 704 to facilitate the flow of print fluid f₁₂ through the membrane 704. The pressure regulators 705 and 719 can also control the pressures P₃ and P₄ to help improve and or initiate the contact of the membrane 704 with the print medium 740 and facilitate the fidelity of the pattern comprising the features 741, 743 and 745. Preferably, the pressure regulators 705 and 719 comprise pressure sensors, gas sources and vacuum generators that are coupled to the computer 703, whereby the pressure sensors measure the pressures P₃ and P₄ and instruct one or more gas sources and/or one or more vacuum generators (not shown) via the computer 703 to maintain a desired pressure differential across the membrane 704.

In a preferred embodiment of the invention, the membrane 704 is an elastic membrane wherein creating a pressure differential across the membrane 704 facilitates coupling the print medium 740 to the micro-stencil structure 701. For example, the pressure regulators 705 and 719 can pressurize the membrane 704, such that P₃ is greater than P₄ thereby causing the membrane 704 to bulge towards the print medium 740 and engage the print medium 704.

In an alternative system 725 of the instant invention, shown in FIG. 11b, the mechanism for coupling a print medium 731 with micro-stencil 726 comprises a drum structure 729 that rolls the print surface of the micro-stencil 726 over the print medium 731 to print features 751, 753, 755 and 757. The system 725 can be configured to move the print medium 731 in a direction D₁ along the micro-stencil 726, such that the medium 731 passes under a stationary or moving rotating drum structure 729. When the medium 731 is flexible, the system 725 can be configured with rollers 760 and 761 for controlling the direction, movement and tension of the print medium 731. The system 725 can also be configured with an accumulator 770 and/or winder for controlling windup of the printed medium. The system 725 can further include alignment features for aligning the stencil 726 with the print medium 731, drying and/or curing means and/or converting stations for cutting and organizing the printed medium.

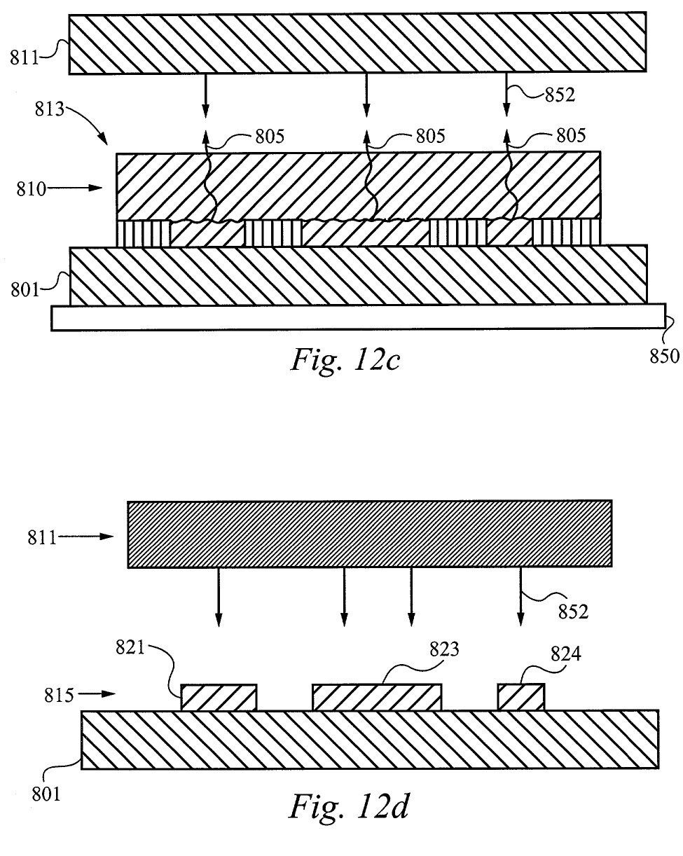

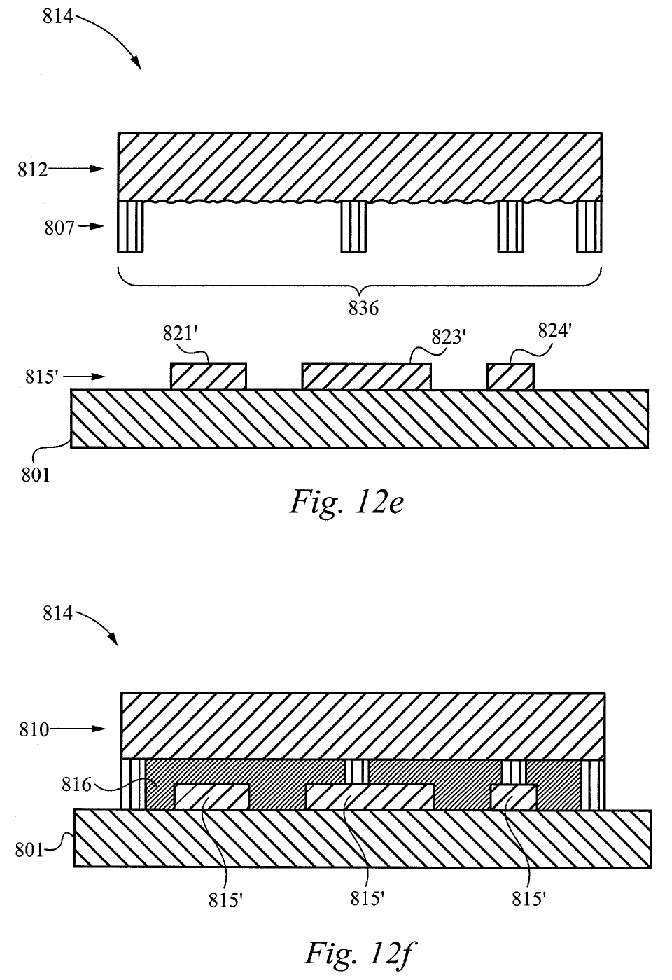

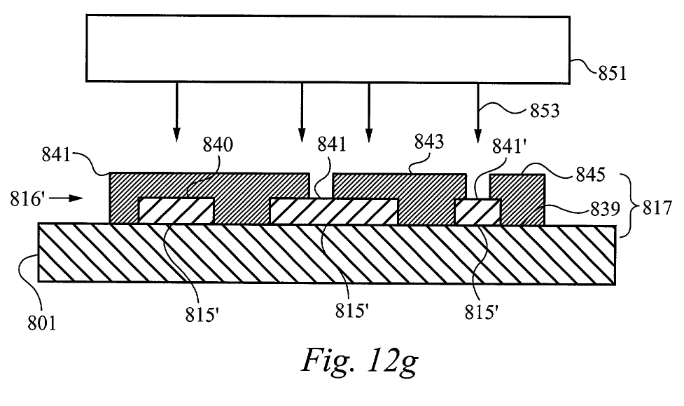

In accordance with the method of the instant invention, micro-stencils can be utilized to fabricate multi-layer print structures, such as illustrated in FIGS. 12a-g. Referring now to FIG. 12a, a micro-stencil 813 comprises a patterned membrane 804 and a means to supply print fluid 810 to the print surface 806 of the micro-stencil 813. The micro-stencil 813 is then utilized to form a first print layer 815 (shown in FIG. 12d) on a suitable substrate 801. To form the first print layer 815, the substrate 801 and a print surface 806 of the micro-stencil 813 are brought together such that print fluid is directly transferred onto the substrate 801 through the membrane 804, as shown in FIG. 12b.

If the means to supply print fluid 810 is suitably transparent to curing radiation 852, the print can be cured with a radiation source 811 while the micro-stencil 813 is in contact with the print medium 801, whereby curing gases 805 are expelled from the print through the micro-stencil 813 as shown in FIG. 12c. Alternatively, or in addition to, the print can be cured with a heat source 850 that heats the print medium 801 with the micro-stencil 813 in contact with the print medium 801. The two-way flow characteristics of the micro-stencil 813 again allow curing gases 805 to be expelled from the print through the micro-stencil 813.

Alternately, the micro-stencil 813 and the substrate 801 are separated, as shown in FIG. 12d, leaving the uncurred first print layer 815 with print features 821, 823 and 824. The first uncurred print layer 815 can then be cured with radiation 852 from a radiation source 811 to form a cured print layer 815′ with solid print features 821′, 823′ and 824′. As stated previously, the need and/or the type of curing used is predicated by the type of print fluid used to form the print layers and the intended use of the multi-layer print structure.

Referring now to FIG. 12e, a second micro-stencil structure 814 comprising a patterned membrane 807 and means to supply a second print fluid 812 is utilized to form a second print layer 816 (shown in FIG. 12g) over the first cured print layer 815′. To form the second print layer 816, the substrate 801 with the first cured print layer 815′ and the print surface 836 of the second micro-stencil structure 814 are brought together such that print fluid is directly transferred to the desired regions over the substrate 801, to overlap regions of the cured first print layer 815′ and/or a combination thereof, as shown in FIG. 12f. The multi-layer print structure 817 shown in FIG. 12g can also have regions 841 and 841′ where the first cured print layer 815′ is exposed through the second print layer 816′. Accordingly, a portion of a third print layer (not shown) can be directly printed to couple to the exposed regions 841 and 841′ of the first print layer 815′. In this way, any number of print layers with any number of layer-to layer interconnects can be formed using the method described above.

After the second print layer 816 is formed, the second print layer 816 can be cured with radiation 853 from a suitable radiation source 851 to form the second cured print layer 816′. The radiation 853 is the same or different from the radiation 852 used to cure the first print layer 815, depending on the type of print fluid used to form the second print layer 816.

The present invention provides an alternative to photo-lithographic methods for fabricating devices with micron and sub-micron features and for fabricating devices with multi-layer structures. Micro-stencil structures of the instant invention are used to directly and selectively print fluids onto a surface such that the overlap regions or contacts between multiple prints within a multi-layer print structure can be readily controlled. Accordingly, the method of the instant invention is particularly well-suited for building electronic devices and bio-chip devices.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention.

What is claimed is:

1. A micro-stencil comprising:
a. a membrane with a receptor surface and a print surface, the print surface being patterned with stencil features; and
b. a flow region through the membrane to allow a print fluid to flow from the receptor surface to the print surface for printing the stencil feature on a medium.

2. The micro-stencil of claim 1, wherein the flow region comprises passages from the receptor surface to the print surface.

3. The micro-stencil of claim 1, further comprising a reservoir for holding and suppling a print fluid.

4. The micro-stencil of claim 3, wherein the reservoir comprises a porous material.

5. The micro-stencil of claim 4, wherein the porous material comprises a material selected from the group consisting metal, glass, quartz, polymer, cellulose, polycarbonate, polytetrafluoroethylene, nylon, polyether sulfone, polypropylene, mixed cellulose and polyvinylidene fluoride.

6. The micro-stencil of claim 4, wherein the porous material is coupled to the receptor surface of the membrane.

7. The micro-stencil of claim 4, wherein a portion of the porous material is positioned within the flow region.

8. The micro-stencil of claim 1, wherein the stencil features comprise lateral feature dimensions of less than 5.0 microns.

9. The micro-stencil of claim 1, wherein the membrane is formed from a resilient material selected from the group consisting of rubber, silicone, urethane, vinyl, acrylic and nylon.

10. The micro-stencil of claim 1, wherein the membrane is formed from polydimethylsiloxane (PDMS).

11. The micro-stencil of claim 1, wherein a portion of the membrane has a thickness of less than 1.0 micron.

12. The micro-stencil of claim 1, wherein the stencil features comprise an array of stencil features.

13. A method of making a micro-stencil comprising:
a. providing a stamp with a master surface having stencil features; and
b. forming a membrane from the stamp, such that the stencil features are patterned through the membrane and wherein a print fluid is capable of passing through a portion of the stencil features to transfer the print fluid onto a print medium surface.

14. The method of claim 13, wherein the membrane is formed by pressing a liquid material between the master surface and a support surface.

15. The method of claim 14, wherein the liquid material is cured while between the master surface and the support surface.

16. The method of claim 14, wherein the membrane is released from the master surface.

17. The method of claim 16, wherein the is membrane is attached to a porous backing.

18. The method of claim 17, wherein the support surface is released from the membrane.

19. The method of claim 13, wherein portions of the support surface are selectively removed to form passages through the support surface.

20. The method of claim 14, wherein the support surface comprises a metal.

21. The method of claim 14, wherein the support surface comprises a porous material.

22. The method of claim 14, wherein the support surface is released from the membrane.

23. The method of claim 22, wherein the membrane is released from the master surface.

24. The method of claim 22, wherein portions of the master surface corresponding to stencil features are selectively removed to from channels through the stamp.

25. The method of claim 22, wherein the master surface is formed from a porous material.

26. The method of claim 13, wherein a portion of the stencil features have lateral dimensions of less than 5.0 microns.

27. The method of claim 13, wherein the membrane is formed from a material selected from the group consisting of rubber, silicone, urethane, vinyl, acrylic and nylon.

28. The method of claim 13, wherein the membrane is formed from polydimethylsiloxane (PDMS).

29. The method of claim 13, wherein the membrane has a thickness of less than 1.0 micron.

30. The method of claim 13, wherein the stencil features comprise an array of stencil features.

31. The method of claim 13, wherein the stamp is formed from a material selected from the group consisting of metal, glass, quartz, silicon and polymer.

32. A method of patterning a micro-stencil comprising:
a. providing a substrate; and
b. forming a print surface patterned with stencil features on the substrate.

33. The method of claim 32, comprising forming a stencil membrane on the substrate, wherein the stencil membrane comprises the stencil features.

34. A method of claim 33, wherein forming the stencil membrane comprises depositing a liquid layer on the substrate and selectively patterning the liquid layer with the stencil features.

35. A method of claim 34, wherein the liquid layer is formed from a material selected from the group consisting of rubber, silicone, urethane, vinyl, acrylic and nylon.

36. The method of claim 34, wherein the stencil membrane is formed from polydimethylsiloxane (PDMS).

37. The method of claim 32, wherein the substrate is formed from a material selected from the group consisting metal, glass, quartz, polymer foam, mixed cellulose, polycarbonate, polytetrafluoroethylene (PTFE), nylon, polyether sulfone (PES), polypropylene, mixed cellulose, polyvinylidene fluoride (PVDF) and polydimethylsiloxane (PDMS).

38. The method of claim 32, wherein the surface is porous with an average pore size between 100 microns to 30 nanometers.

39. The method of claim 33, wherein the liquid layer is cured to form a solid layer prior to selectively patterning the liquid layer with the stencil features.

40. The method of claim 33, wherein forming a stencil membrane on the substrate comprises forming a mask and etching through the mask to form the stencil features.

41. The method of claim 39, wherein the solid layer is patterned to form the stencil features using a method selected from the group consisting of laser ablation, ion beam treatment, electron beam treatment and reactive ion etch.

42. The method of claim 32, wherein a portion of the stencil features have lateral dimensions of less than 5.0 microns.

43. The method of claim 33, wherein a portion of the stencil membrane has a thickness of less than 1.0 microns.

44. The method of claim 33, wherein forming the stencil membrane comprises depositing a liquid material on the substrate to form the stencil features.

45. The method of claim 32, comprising selectively patterning the substrate to form a relief surface defining the stencil features.

46. The method of claim 45, comprising forming the stencil membrane, wherein forming the stencil membrane comprises depositing liquid polymeric layer on the relief surface, curing the liquid polymer layer and removing the cured polymer layer from the substrate surface.

47. The method of claim 45, comprising forming the stencil membrane, wherein forming the stencil membrane comprises selectively depositing a polymer material on the relief surface of the substrate.

48. The method of claim 33, wherein the stencil membrane is released from the substrate.

49. The method of claim 33, wherein the stencil features comprise an array of stencil features.

50. The method of claim 33, comprising rendering the substrate porous.

51. The method of claim 50, wherein rendering the substrate porous comprises exposing the substrate to a high energy radiation source.

52. The method of claim 50, wherein rendering the substrate porous comprise exposing the substrate to a chemical etchant.

53. A system for printing micro-patterns, the system comprising:
a. a micro-stencil with stencil features;
b. a print fluid supply coupled to the micro-stencil for providing a print fluid through the micro-stencil; and
c. a mechanism for coupling a print surface to the micro-stencil for direct transfer of the print fluid in a pattern of the stencil features onto a print medium.

54. The system of claim 53, wherein the micro-stencil comprises a membrane with portions of the stencil features passing through the membrane.

55. The system of claim 53, wherein the print fluid supply comprises a reservoir.

56. The system of claim 55, wherein the reservoir comprises a porous material coupled to the micro-stencil.

57. The system of claim 53, further comprising a pressure regulator to controllably regulate a pressure difference between the print medium and the print fluid.

58. The system of claim 53, further comprising means to move the print medium and the micro-stencil relative to each other.

59. The system of claim 53, further comprising means to align the print medium with the micro-stencil.

60. The system of claim 53, wherein a portion of the micro-stencil comprises stencil features having lateral dimensions of less than 5.0 microns.

61. The system of claim 54, wherein the membrane has a thickness of less than 1.0 micron.

62. The system of claim 53, wherein the mechanism for coupling the print medium to the micro-stencil comprises a press structure.

63. The system of claim 53, wherein the mechanism for coupling the print medium to the micro-stencil comprises a drum structure.

64. The system of claim 54, wherein the membrane is an elastic membrane and wherein the mechanism for coupling the print medium to the micro-stencil comprises a pressurizing means, whereby the pressurizing means deforms the elastic membrane towards the print medium.

65. A method for building print structures comprising:
a. placing a first micro-stencil comprising a first stencil membrane with a first set of stencil features near a substrate surface; and
b. passing a first print fluid through the first stencil membrane to transfer a first print layer onto the substrate surface.

66. The method of claim 65, wherein the first print fluid is passed from a receptor surface of the stencil membrane to a print surface of the stencil membrane.

67. The method of claim 65, further comprising curing the first print layer.

68. The method of claim 67, wherein the first print layer is cured by a radiation source.

69. The method of claim 68, wherein the first print layer is cured while the first micro-stencil is near the substrate, whereby curing gases escape from the first print layer and pass through the first stencil membrane.

70. The method of claim 69, wherein a pressure differential is controlled across the first stencil membrane such that the pressure at the receptor surface of the first stencil membrane is lower than the pressure at the print surface of the first stencil membrane, while curing the first print layer.

71. The method of claim 65, wherein a pressure differential is controlled across the stencil membrane such that the pressure at the print surface of the first stencil membrane is less than the pressure at the receptor surface of the first stencil membrane while passing the first print fluid through the first stencil membrane.

72. The method of claim 65, further comprising:
a. placing a second micro-stencil comprising a second stencil membrane with a second set of stencil features near the substrate surface; and
b. passing a second print fluid through the second stencil membrane to transfer a second print layer onto the substrate surface.

73. The method of claim 72, wherein a portion of the first print layer and the second print layer overlap.

74. The method of claim 72, further comprising curing the second print layer.

75. The method of claim 72, further comprising aligning the first micro-stencil with the substrate surface prior to passing the first print fluid through the first micro-stencil and aligning the second micro-stencil with the substrate surface prior to passing the second print fluid through the second micro-stencil.

76. The method of claim 75, wherein aligning the first micro-stencil and the second micro-stencil with the substrate surface comprises aligning marks on the first micro-stencil and the second micro-stencil with complimentary marks on the substrate surface.

77. The method of claim 65, wherein the first print fluid is selected from the group consisting of a gas, a liquid and a liquid suspension.

78. The method of claim 65, wherein the first print fluid comprises nano-particles.

79. The method of claim 78, wherein the nano-particles comprise at least one material selected form the group consisting of metal, semi-conductor and insulator.

80. The method of claim 72, wherein the second print fluid is selected from the group consisting of a gas, liquid and liquid suspension.

81. The method of claim 72, wherein the second print fluid comprises nano-particles.

82. The method of claim 81, wherein the nano-particles comprise at least one material selected from the group consisting of metal, semi-conductor and insulator.

83. A method for building a multi-layer print structure comprising:
a. placing a first micro-stencil near a substrate surface;
b. passing a first print fluid through the micro-stencil to transfer a first set stencil features onto the substrate surface and forming a first print layer;
c. placing a second micro-stencil near the first print surface; and
d. passing a second print fluid through the second micro-stencil to transfer a second set of stencil features onto the substrate surface and forming a second print surface.

84. The method of claim 83, wherein a portion of the first set of stencil features and the second set of stencil features overlap.

85. The method of claim 84, wherein the overlapping portions of the first set of stencil features and the second set of stencil features form an array.

86. The method of claim 83, wherein a portion of the stencil features of the first micro-stencil and a portion of the second micro-stencil comprise lateral dimensions of less than 5.0 microns.

87. The method of claim 83, wherein first micro-stencil and the second micro-stencil comprise a resilient polymeric membrane.

88. The method of claim 83, wherein at least one of the first and the second print fluids comprise an amino acid moiety.
